(19) United States
(12) Patent Application Publication
(10) Pub. No.: US 2017/0250444 A1
(43) Pub. Date: Aug. 31, 2017

(54) HALOGEN-FREE ELECTROLYTES

(71) Applicant: VIRGINIA COMMONWEALTH UNIVERSITY, Richmond, VA (US)

(72) Inventors: Purusottam JENA, Richmond, VA (US); Santanab GIRI, Richmond, VA (US); Swayamprabha BEHERA, Richmond, VA (US)

(21) Appl. No.: 15/513,611

(22) PCT Filed: Sep. 24, 2015
(86) PCT No.: PCT/US2015/051934

§ 371 Date: Mar. 23, 2017

Related U.S. Application Data
(60) Provisional application No. 62/055,391, filed on Sep. 25, 2014.

(51) Int. Cl. H01M 10/0568; H01M 10/054; H01M 10/0569; H01M 10/0525

(52) U.S. Cl. CPC H01M 10/0568; H01M 10/0525; H01M 10/054; H01M 10/0569; H01M 2220/20; H01M 2220/30; H01M 2300/0034

(57) ABSTRACT

Compounds (salts) for use as electrolytes, e.g. in batteries such as Li ion, Na ion and Mg ion batteries are provided. The negative ions (anions) of the compounds are complex molecules which do not contain halogens, and thus exhibit improved safety, and yet have electron affinities that are equal to or greater than those of halogens. In addition, the binding energy between Li+ and the anions is relatively small so ions can move easily from one electrode to the other in solutions in which the compounds are dissolved. A further advantage is that the affinity of the electrolyte for water is also relatively low so that batteries in which the electrolytes are used have longer lives than those of the prior art.

### CROSS-REFERENCE TO RELATED APPLICATIONS

This application claims benefit of U.S. provisional patent application 62/055,391, filed Sep. 25, 2014, the complete contents of which is hereby incorporated by reference.

### STATEMENT OF FEDERALLY SPONSORED RESEARCH AND DEVELOPMENT

This invention was made with government support under grant number DE-FG02-96ER45579 awarded by the United States Department of Energy. The United States government has certain rights in the invention.

### BACKGROUND OF THE INVENTION

Field of the Invention

The invention generally relates to halogen-free electrolytes. In particular, the anion portions of the halogen-free electrolytes are complex molecules having electron affinities that are close to or greater than those of halogens, and the halogen-free electrolytes are suitable for use in batteries (e.g. Li-ion, Na-ion, Mg-ion, etc. batteries) and other applications.

Background

Li-ion batteries, due to their light weight and high energy density, play an important role in modern portable electronics [1-3]. Three primary components of a Li-ion battery are the anode, cathode, and electrolyte. While graphite is used as the most commercially popular anode, the cathode is generally composed of metal oxides, layered oxide (such as lithium cobalt oxide), polyanion (such as lithium iron phosphate), or a spinel (such as lithium manganese oxide) [4-7]. The Li⁺ ions that move from anode to cathode when discharging and reverse when charging are supplied by the electrolytes. Considerable research is under way to improve the cost, efficiency, durability, and safety of the Li-ion batteries by improving materials for anodes, cathodes, and electrolytes [8-15].

The current electrolytes that are available for use include lithium salts such as LiAsF₆, LiBF₄, LiPF₆, LiFePO₄, LiClO₄, LiN(SO₂F)₂, and LiN(SO₂CF₃)₂, combined with organic solvents like ethylene carbonate, dimethyl carbonate, etc. [16-19]. Although these electrolytes are commercially available and popularly used in Li-ion batteries, they have certain disadvantages. With the exception of LiFePO₄ the above electrolytes contain halogens which are toxic and corrosive. LiAsF₆ is poisonous while LiClO₄ is explosive. BE₄⁺ of LiBF₄ creates problem on anode surface, whereas LiN(SO₂CF₃)₂ corrodes the cathode [20]. LiPF₆ decomposes to PF₅ and LiF, the former readily hydrolyzing to form HF and PF₃O. These two products are very reactive on both cathode and anode surfaces and impact negatively on electrode performance [21]. Recently it has been shown that LiFePO₄ suffers from the same memory effect that has plagued nickel-cadmium and nickel-metal hydride batteries which gradually loose usable capacity if recharged repeatedly after being only partially discharged [22]. Furthermore, Li-ion batteries have limited performance at elevated temperatures and due to the surface phenomena on both electrodes, their life cycle is also limited [23]. The safety features of commercially prepared Li-ion batteries are also insufficient for large size applications [24, 25]. To tackle these problems several attempts have been made by either introducing new solvents or using different salts and additives [26, 27]. However, there is an ongoing need to identify new compounds that are suitable for use as electrolytes, e.g. in Li-ion and other light metal ion (Na and Mg) batteries, but which do not have these undesirable characteristics.

There are three characteristics of electrolytes that need improvement. First, they should be halogen-free to improve safety. Second, since the binding energy between the metal ion and the anionic part of the salt plays an important role in ion conduction, it should be small so that ions can move easily from one electrode to the other. Third, the affinity of the electrolyte to water should also be low so as to increase battery life.

### SUMMARY OF THE INVENTION

The present invention provides compounds (salts) for use as electrolytes, e.g. in Li-ion and other metal-ion batteries or other applications. The negative ions of the compounds are complex molecules which advantageously do not contain halogens, and thus exhibit improved safety yet they have properties similar or superior to those of current anions in Li-ion battery electrolytes. Their electron affinities are close, comparable or similar to those of halogens (e.g. within about 0.5 eV of Cl), or equal to or greater than those of halogens. In addition, the binding energy between Li⁺ and the anionic part of the salt is relatively small so Li⁺ ions can be easily removed from the salt and move easily from one electrode to the other in solutions in which the compounds are dissolved. A further advantage is that the affinity of the electrolyte for water is also relatively low so that Li-ion batteries in which the electrolytes are used have longer lives than those of the prior art. Exemplary compounds which may be used as described herein include LiNO₃, LiCB₁₁H₁₂, LiBH₄, LiB₃H₈ and Li₂B₁₂H₁₂. Electrically conductive solutions comprising the electrolytes dissolved in a carrier suitable for use in Li-ion batteries are also provided, as are devices which contain the solutions.

Other features and advantages of the present invention will be set forth in the description of invention that follows, and in part will be apparent from the description or may be learned by practice of the invention. The invention will be realized and attained by the compositions and methods particularly pointed out in the written description and claims hereof.

It is an object of this invention to provide a battery comprising an electrolyte dissolved in a carrier, wherein negative ions of the electrolyte are complex molecules, do not contain halogens, and have electron affinities that are equal to or greater than those of halogens. In some aspects, the battery is a Li ion battery, a Na ion battery or an Mg ion battery. In some aspects, the electrolyte is, for example, LiCB₁₁H₁₂, LiBH₄, LiB₃H₈, LiNO₃ or Li₂B₁₂H₁₂. In other aspects, the carrier is, for example, ethylene carbonate, dimethyl carbonate, allyl methyl sulfone; diethyl carbonate; diethyl sulfite; ethylene sulfite; ethyl methyl carbonate; fluoroethylene carbonate 99%; 3-(methylsulfonyl)-1-propyne; propylene carbonate; 1,2-propyleneglycol sulfite; propylene sulfate; 1,3-propylene sulfite; vinylene carbonate; trans-2,3-butylene carbonate; {2-[2-(2-methoxyethoxy)ethoxy]ethoxy} trimethylsilane; bis{2-[2-(2-methoxyethoxy)ethoxy]ethoxy}dimethylsilane; {3-[2-(2-(2-methoxyethoxy)ethoxy)ethoxy]-propyl}trimethylsilane; or {[2-(2-(2-methoxyethoxy)ethoxy)ethoxy]-methyl} trimethylsilane.

The invention further provides rechargeable devices or vehicles comprising at least one battery comprising an electrolyte dissolved in a carrier, wherein negative ions of the electrolyte are complex molecules, do not contain halogens, and have electron affinities that are equal to or greater than those of halogens. In some aspects, the battery is a Li ion battery, a Na ion battery or an Mg ion battery. In some aspects, the electrolyte is, for example, LiCB₁₁H₁₂, LiBH₄, LiB₃H₈, LiNO₃ or Li₂B₁₂H₁₂. In other aspects, the carrier is, for example, ethylene carbonate, dimethyl carbonate, allyl methyl sulfone; diethyl carbonate; diethyl sulfite; ethylene sulfite; ethyl methyl carbonate; fluoroethylene carbonate 99%; 3-(methylsulfonyl)-1-propyne; propylene carbonate; 1,2-propyleneglycol sulfite; propylene sulfate; 1,3-propylene sulfite; vinylene carbonate; trans-2,3-butylene carbonate; {2-[2-(2-methoxyethoxy)ethoxy]ethoxy} trimethylsilane; bis{2-[2-(2-methoxyethoxy)ethoxy]ethoxy}dimethylsilane; {3-[2-(2-(2-methoxyethoxy)ethoxy)ethoxy]-propyl}trimethylsilane; or {[2-(2-(2-methoxyethoxy)ethoxy)ethoxy]-methyl} trimethylsilane. battery comprising an electrolyte dissolved in a carrier, wherein negative ions of the electrolyte are complex molecules, do not contain halogens, and have electron affinities that are equal to or greater than those of halogens. In some aspects, the battery is a Li ion battery, a Na ion battery or a Mg ion battery. In some aspects, the electrolyte is, for example, LiCB₁₁H₁₂, LiBH₄, LiB₃H₈, LiNO₃ or Li₂B₁₂H₁₂. In other aspects, the carrier is, for example, ethylene carbonate, dimethyl carbonate, allyl methyl sulfone; diethyl carbonate; diethyl sulfite; ethylene sulfite; ethyl methyl carbonate; fluoroethylene carbonate 99%; 3-(methylsulfonyl)-1-propyne; propylene carbonate; 1,2-propyleneglycol sulfite; propylene sulfate; 1,3-propylene sulfite; vinylene carbonate; trans-2,3-butylene carbonate; {2-[2-(2-methoxyethoxy)ethoxy]ethoxy} trimethylsilane; bis{2-[2-(2-methoxyethoxy)ethoxy]ethoxy}dimethylsilane; {3-[2-(2-(2-methoxyethoxy)ethoxy)ethoxy]-propyl}trimethylsilane; or {[2-(2-(2-methoxyethoxy)ethoxy)ethoxy]-methyl} trimethylsilane. In some aspects, the rechargeable device is, for example, a cell phone, a word processing device, a media storage device or a tool.

The invention also provides solutions comprising i) an electrolyte selected from the group consisting of LiCB₁₁H₁₂, LiBH₄, LiB₃H₈, LiNO₃ and Li₂B₁₂H₁₂, and ii) a carrier selected from the group consisting of ethylene carbonate, dimethyl carbonate, allyl methyl sulfone; diethyl carbonate; diethyl sulfite; ethylene sulfite; ethyl methyl carbonate; fluoroethylene carbonate 99%; 3-(methylsulfonyl)-1-propyne; propylene carbonate; 1,2-propyleneglycol sulfite; propylene sulfate; 1,3-propylene sulfite; vinylene carbonate; trans-2,3-butylene carbonate; {2-[2-(2-methoxyethoxy)ethoxy]ethoxy} trimethylsilane; bis{2-[2-(2-methoxyethoxy)ethoxy]ethoxy}dimethylsilane; {3-[2-(2-(2-methoxyethoxy)ethoxy)ethoxy]-propyl}trimethylsilane; and {2-[2-(2-(2-methoxyethoxy)ethoxy)ethoxy]-methyl} trimethylsilane. Uses of the electrolyte include its use in a battery, for example, a Li ion battery, a Na ion battery or a Mg ion battery.

### BRIEF DESCRIPTION OF THE DRAWINGS

FIG. 1: Optimized geometries of different anions in currently used electrolytes in Li-ion batteries

FIG. 2: Optimized geometries of anions of four halogen-free electrolytes. Also given for comparison are two other halogen-containing anions that are not currently used in commercial applications.

FIG. 3: Comparison between vertical detachment energies (VDEs, i.e. energy needed to remove an electron from the ion without changing its structure) and binding energies of Li⁺ and H₂O in current as well as predicted halogen-free electrolytes.

FIG. 4. Schematic representation of a Li-ion battery comprising an electrolyte of the invention.

FIG. 5. Schematic representation of a device that is powered by a Li-ion battery comprising an electrolyte of the invention.

### DETAILED DESCRIPTION

The invention provides negative ions (anions) in compounds (e.g. salts) for use as electrolytes in Li-ion and other metal-ion batteries. The compounds advantageously do not contain halogens (e.g. Cl, Br, etc.) and are thus “environmentally friendly” and safer to use than the halogen-containing compounds of the prior art. The negative ions of the electrolytes provided herein are complex molecules which, even though they do not contain halogens, have electron affinities that are equal to or greater than those of halogens, yet the binding energy between Li⁺ and the anionic part of the salt is relatively small and the affinity for water is also advantageously low. Examples of such compounds include but are not limited to: LiNO₃, LiCB₁₁H₁₂, LiBH₄, LiB₃H₈ and Li₂B₁₂H₁₂, and corresponding salts of other metals such as Na, Mg, etc.

The following definitions are used throughout:

The electron affinities of the anion portions of the halogen-free electrolytes described herein are comparable to those of halogens. In other words, they are close to (e.g. within about 0.5 eV of the electron affinity of Cl), equal to, or greater than those of halogens such as Cl. The electron affinity of Cl is generally recognized as approximately 3.612 eV (about 348.575 kJoules/mol). Thus, the electron affinities of the anionic portions of the present electrolytes as no less than about 3.1 eV.

An electrolyte is a substance that separates into ions (cations and anions) when dissolved in a polar solvent, such as water, forming a solution that conducts an electrical current. Electrolytes act as ion carriers, e.g. between an anode and a cathode when current flows through an external source. As used herein, “electrolyte” may also refer to a solution which contains such a substance dissolved therein.

A lithium-ion battery (Li-ion battery, LIB) is a member of a family of rechargeable (secondary) battery types in which lithium ions move from the negative electrode to the positive electrode during discharge and back when charging. Similarly, in Na-ion and Mg-ion batteries the negative ions of the electrolytes are the same as those in Li-ion batteries.

“Solution” refers to a homogeneous mixture composed of only one phase. In such a mixture, a solute (e.g. an electrolyte) is dissolved in a solvent (carrier).

As used herein, a “complex molecule” refers to a compound comprising more than one type of element e.g. comprising from about two to about four different types of elements (e.g. about 2, 3, or 4), which are chemically bonded to act as one, i.e. as a single unit. The anionic portions of the electrolytes described herein are complex molecules. Preferred components of the complex molecules include but are not limited to: B, H, N, O and C.

The anions of the electrolytes provided herein have electron affinities that, in some applications, are equal to or greater than those of halogens. For example, as indicated by the vertical detachment energies (VDEs) of the anionic portion of the electrolytes (i.e. the energy needed to remove an electron) is e.g. in the range of at least from about 3 to about 10 eV, or from about 4 to about 9 eV. For example, the VDE is generally at least about 4.1, 4.2, 4.3, 4.4, 5.4, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0, including each 0.01 decimal value in between (e.g. 4.11, 4.12, 4.13, 4.14, 4.15, and so on up to 9.00).

In applications having lithium, the binding energy of Li⁺ affinity to the anionic portion of the electrolytes is sufficiently low to permit the ready detachment and flow of Li⁺ cations in polarized solutions in which the electrolytes are dissolved. For example, ΔE_{Li}⁺ of the compounds of the invention generally range from at most about 5.0 to about 8.0 eV, and generally are at most about 5.5 to about 7.5 eV, e.g. about 5.5, 5.6, 5.7, 5.8, 5.9, 6.0, 6.1, 6.2, 6.3, 6.4, 6.5, 7.0, 7.1, 7.2, 7.4, 7.4 or 7.5 eV, including each 0.01 decimal value in between (e.g. 5.51, 5.52, 5.53, 5.54, 5.55 eV, and so on up to about 7.50 eV).

The binding affinity of the electrolytes described herein towards water is also favorably low for their use, and is generally in the range of at most from about 1.5 to about 0.85 eV, or from about 1.10 to about 0.90 eV, e.g. is generally at most about 1.10, 1.09, 1.08, 1.07, 1.06, 1.05, 1.04, 1.03, 1.02, 1.01, 1.00, 0.99, 0.98, 0.97, 0.96, 0.95, 0.94, 0.93, 0.92, 0.91, or 0.90 eV, and may be lower.

Exemplary types of atoms that are components of the anions comprised in the electrolytes described herein include but are not limited to: N, O, B, H, C, S, P, and As. Anions and/or categories of anions that make up the negatively charged portion of the electrolytes of the invention include but are not limited to: NO₃, CB₁₁H₁₂, BH₄, B₃H₈ and B₁₂H₁₂. In some aspects, the anion has a general formula R1-Bx-Hy, wherein R1 may be present or absent and if present is a C atom, and x and y range from 1-12. Specific examples of suitable anions include but are not limited to: NO₃⁻, CB₁₁H₁₂⁻, BH₄⁻, B₃H₈⁻ and B₁₂H₁₂⁻².

Exemplary liquid solvents (carriers) that may be used to dissolve the compounds disclosed herein during use, e.g. in a Li-ion battery, include but are not limited to: ethylene carbonate, dimethyl carbonate, allyl methyl sulfone; diethyl carbonate; diethyl sulfite; ethylene sulfite; ethyl methyl carbonate; fluoroethylene carbonate 99%; 3-(methylsulfonyl)-1-propyne; propylene carbonate; 1,2-propyleneglycol sulfite; propylene sulfate; 1,3-propylene sulfite; vinylene carbonate; trans-2,3-butylene carbonate; silane compounds such as {2-[2-(2-methoxyethoxy)ethoxy]ethoxy} trimethylsilane, bis{2-[2-(2-methoxyethoxy)ethoxy]ethoxy}dimethylsilane, {3-[2-(2-(2-methoxyethoxy)ethoxy)ethoxy]-propyl}trimethylsilane and {2-[2-(2-(2-methoxyethoxy)ethoxy)ethoxy]-methyl} trimethylsilane; etc.

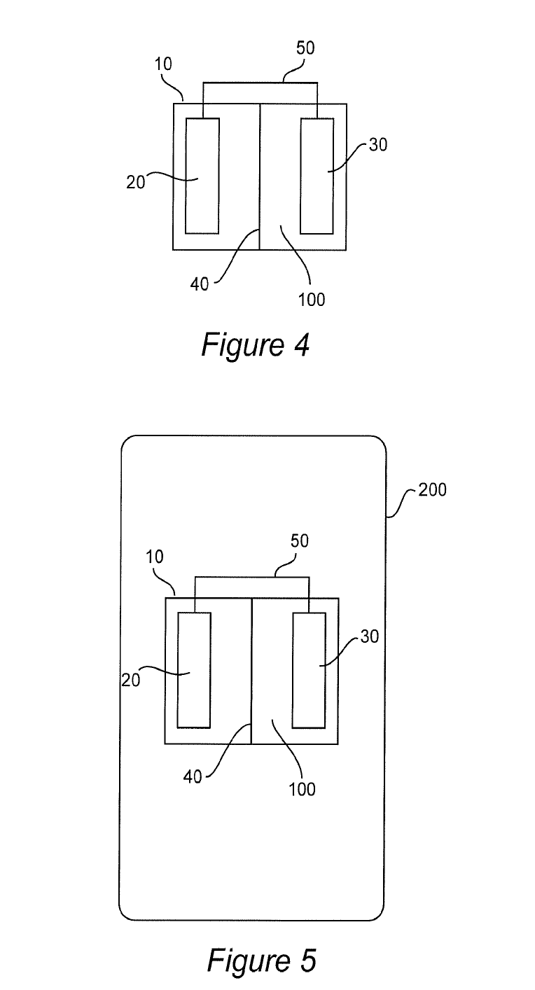

A schematic representation of a Li-ion battery of the invention is depicted in FIG. 4. In FIG. 4, Li-ion battery 10 is comprised of anode 20, cathode 30 and separator 40. Anode 20 and cathode 30 are connected via closed external circuit 50, through which current flows to perform useful work. Electrolyte 100 comprises the compounds described herein. Anode 20 (the negative electrode) may be formed from any suitable material(s), examples of which include but are not limited to: graphite, lithium, Fe₃O₄ nano materials, etc. Cathode 30 (the positive electrode) may be formed from any suitable material(s), examples of which include but are not limited to: a layered oxide (such as lithium cobalt oxide), a polyanion (such as lithium iron phosphate) a spinel (such as lithium manganese oxide), etc. Separator 40 may be formed from, for example, nonwoven fibers (cotton, nylon, polyesters, glass), polymer films (polyethylene, polypropylene, poly (tetrafluoroethylene), polyvinyl chloride, naturally occurring substances (rubber, asbestos, wood), and the like. Pores of the separator are of sufficient size to allow the ions of the electrolyte to pass through.

The electrolytes described herein may be used in any suitable type of Li-ion, Na-ion, or Mg-ion battery. Exemplary types include, for example, lithium cobalt oxide, lithium manganese oxide, lithium iron phosphate, lithium nickel manganese cobalt oxide, lithium nickel cobalt, aluminum oxide, and lithium titanate, to name a few. The batteries may be of any suitable size or shape, and may be used alone or in a series. Various designs and styles of Li-ion batteries are described, for example, in issued U.S. Pat. No. 9,136,537 (Moon, et al.), U.S. Pat. No. 9,123,957 (Kim, et al.), U.S. Pat. No. 9,118,045 (Marshall, et al.), U.S. Pat. No. 9,105,909 (Ha, et al.), U.S. Pat. No. 9,112,221 (Park, et al.), U.S. Pat. No. 9,088,036 (Roh, et al.), the complete contents of each of which are hereby incorporated by reference in entirety. The present electrolytes may be employed in any such design or type of Li-ion battery.

The Li-ion batteries described herein have a wide range of applications, which include but are not limited to: rechargeable devices such as mobile computing devices, cell phones, tools, watches, electric vehicles (e.g. cars, airplanes, etc.),

A schematic representation of a device comprising (e.g. powered by) a Li-ion battery of the invention is shown in FIG. 5. The notation for Li-ion battery 10 is the same as described above, and the device per se is indicated as device 200.

This new class of halogen-free negative ions can also be used in the design and synthesis of hybrid solar cells and perovskites.

It is to be understood that this invention is not limited to particular embodiments described, as such may, of course, vary. It is also to be understood that the terminology used herein is for the purpose of describing particular embodiments only, and is not intended to be limiting.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference, and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### EXAMPLES

### Example 1

### Superhalogens as Building Blocks of Halogen-Free Electrolytes in Li-Ion Batteries

Abstract: Most of the electrolytes used in current Li-ion batteries contain halogens which are toxic. In an effort to search for halogen-free electrolytes, we studied the electronic structure of these complexes using first-principles theory. The results revealed that all the current electrolytes are superhalogens, i.e. the vertical electron detachment energies of the moieties that make up the negative ions are larger than that of any halogen atom. Realizing that several superhalogens that do not contain a single halogen atom exist, we studied their potential as effective electrolytes by calculating not only the energy needed to remove a Li+ ion but also their affinity towards H₂O. Several halogen-free electrolytes are identified among which Li(CB₁₁H₁₂) is shown to have exemplary potential.

We begin by analyzing the electronic structure of the negative ions of the Li salts. These are BF₄⁻, PF₆⁻ AsF₆⁻, FePO₄⁻, ClO₄⁻, N(SO₂F)₂⁻, and N(SO₂CF₃)₂⁻, as discussed above. We note that the oxidation state of B is +3 while it is +5 for P and As. Fluorine, on the other hand is electronegative and needs only one electron to satisfy its electronic shell closure. Consequently, BF₄, PF₆, and AsF₆ need one extra electron for shell closing. With electronic configuration of Fe₂+, P₅+, and O₂—, FePO₄ also needs one extra electron for electron shell closing. In the case of ClO₄⁻, four oxygen atoms need 8 electrons to close their electronic shells, but Cl can contribute a maximum of 7 electrons. Thus, one extra electron is needed to fulfill the electronic shell closure. Electron counting in N(SO₂F)₂ and N(SO₂CF₃)₂ is slightly more complicated as the oxidation state of N can vary from −3 to +5 and that of S from −2 to +6, depending upon the nature of the ligand. For example, in N₂O, N is in +1 state while in NH₃ it is in the −3 state. In N(SO₂F)₂, N, S, O, and F have oxidation states of +1, +4, −2, and −1, respectively. In N(SO₂CF₃)₂, on the other hand, the oxidation state of N is −3. Thus, while SO₂F needs one electron to have electronic shell closure, SO₂CF₃ has one more than what is needed for electronic shell closure. Consequently, SO₂F behaves like a halogen atom while SO₂CF₃ behaves like an alkali atom. However, both N(SO₂F)₂ and N(SO₂CF₃)₂ need an extra electron to close their electronic shells, and hence they serve as negative ions in the Li salt. Since the extra electron in all the above moieties is distributed over a large phase space, the reduction in electron-electron repulsion makes these molecules very stable as anions. In 1980's by Gutsev and Boldyrev [28] had shown that when a core metal atom, M is surrounded by halogen atoms, X such that their number exceeds the maximal valence, k of M by one, the resulting molecule, MFₖ₊₁ will have electron affinities larger than that of any halogen atom. This is because the added electron would be delocalized over (k+1) halogen atoms, thus reducing electron-electron repulsion, and hence increasing their stability. To confirm that the moieties that make up the anions of current electrolytes are indeed superhalogens, we optimized the structure of the anions and calculated their vertical detachment energies (VDE), i.e. energy needed to remove an electron. The VDEs are determined from the difference between the ground state energies of the anions and their corresponding neutrals at the anion geometry. First principles calculations based on density functional theory with hybrid functional for exchange-correlation potential were carried out to first find the ground state geometries and total energies of anionic BF₄, PF₆ , AsF₆, FePO₄, ClO₄, N(SO₂F)₂, and N(SO₂CF₃)₂ species. All the anions and their Li salts were optimized at wB97XD level of theory ^{[29]} using 6-311+G(d) basis set. Although from our past studies ^{[30-32]} we found that B3LYP level of theory can provide reasonably good results, wB97XD level of theory is used to include the dispersion and long range interaction in our calculation. Frequency analysis was performed at the same level of theory to ensure that there are no imaginary frequencies and the structures belong to a minimum in the potential energy surface. All the optimizations were performed using Gaussian 09 program^{[33]} and the structures were modeled using Gauss-view program ^{[33]}.

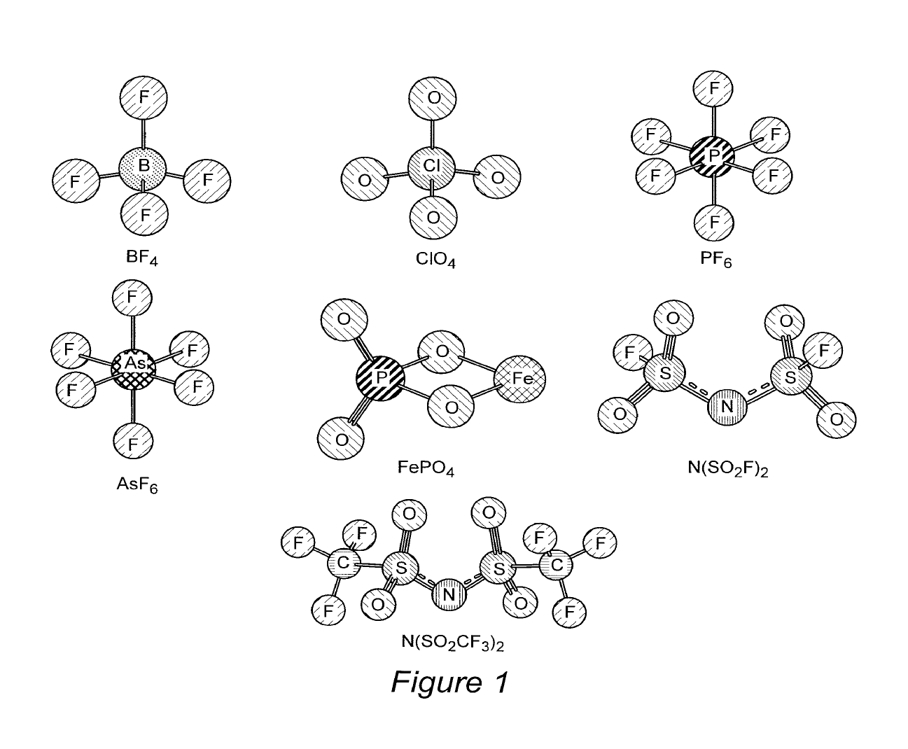

The optimized geometries of BF₄—, PF₆— AsF₆—, FePO₄—, ClO₄—, N(SO₂F)₂—, and N(SO₂CF₃)₂— anions are given in FIG. 1 and their corresponding VDEs are presented in Table 1. Note that in all cases, the VDEs are larger than the electron affinity of chlorine. Thus, all these moieties are superhalogens. Of particular note is N(SO₂F)₂. The calculated VDE of SO₂F is 4.74 eV which already makes it a superhalogen. Since N(SO₂F)₂ is composed of SO₂F superhalogens and its VDE is larger than that of SO₂F, it can be considered as a hyperhalogen ^{[34]}. Unlike conventional superhalogens where metal atoms serve as the core and halogens as ligands, in N(SO₂CF₃)₂⁻, SO₂CF₃ serves as the cation core and N, with an oxidation state of −3, serves as the electronegative ligand.

Having established that all the negative ions of the current electrolytes are superhalogens, we note that this field has been developing for more than 30 years. Although the superhalogens studied in 1980's and 1990's mostly consisted of a simple metal atom at the core surrounded by halogen ligands, extensive research over the past decade has greatly expanded the pool of superhalogens. These include transition metal atoms at the core as well as non-halogens such as O as ligands. Superhalogens that contain neither a metal nor a halogen atom have also been found to exist ^{[35-38]}. Examples of these superhalogens are: NO₃, CN, BH₄, BO₂, and CB₁₁H₁₂. Herein we examined if some of these superhalogens may also be good candidates for electrolytes in Li-ion batteries.

To be competitive with current electrolytes, the halogen-free electrolytes must satisfy two important criteria outlined before, namely, the energy to remove Li⁺ from the salt should be same or less than that in current electrolytes. Secondly, the affinity of halogen-free electrolytes towards water must not be larger than that of current electrolytes. These quantities are evaluated using the equations,

ΔE_{Li+}=(Eₐₙᵢₒₙ+E_{Li}_{⁺})−E_{Salt} (1)

ΔE_{H}_{₂}_{O}=(Eₛₐₗₜ+E_{H}_{₂}_{O})−E_{Salt+H}_{₂}_{O} (2)

These energies are given in Table 1 for the current commercially used electrolytes. We have also calculated the molar volumes of these anions to see whether they have any effect on binding energy. The geometries of Li-salts and their H₂O complexes were also determined (not shown).

TABLE 1
Calculated Vertical Detachment Energy (VDE, eV), Li⁺ binding
energy (ΔE_{Li}⁺, eV), binding energy with H₂O (ΔE_{H2O},
eV) and molar volume (cm**3/mol) at wB97XD/6-311 +
G(d) at level for currently used electrolytes in Li-ion battery

| Anions | VDE | ΔE_{Li}⁺ | ΔE_{H2O} | Volume |
|---|---|---|---|---|
| FePO₄ | 4.32 | 7.38 | 1.04 | 57.24 |
| ClO₄ | 5.83 | 5.96 | 1.02 | 50.63 |
| N(SO₂F)₂ | 6.89 | 5.82 | 1.02 | 80.14 |
| N(SO₂CF₃)₂ | 7.01 | 6.01 | 0.99 | 126.01 |
| BF₄ | 7.66 | 6.08 | 1.41 | 46.62 |
| PF₆ | 8.55 | 5.73 | 1.07 | 63.27 |
| AsF₆ | 8.91 | 5.65 | 1.09 | 58.17 |

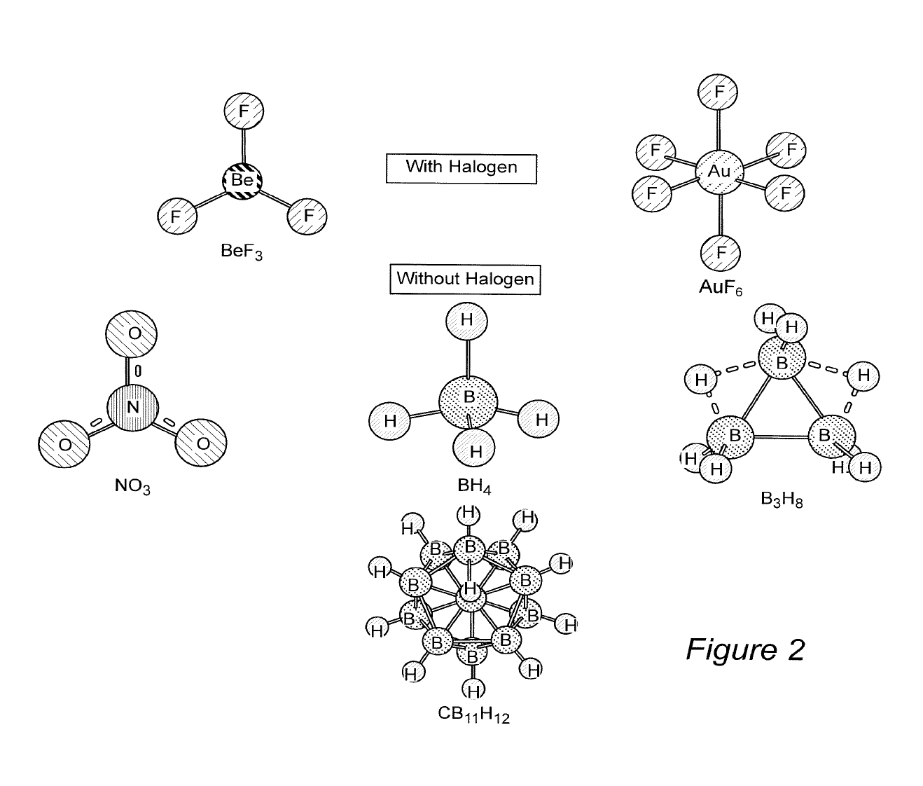

The data presented in Table 1 shows that VDEs range between 4.32 eV to 8.91 eV, while ΔE_{Li}⁺ ranges from 5.73 eV to 7.38 eV. The molar volumes of N(SO₂F)₂ and N(SO₂CF₃)₂ are larger than any other anions, as is evident from the large size of these moieties. One would expect ΔE_{Li}⁺ to decrease with increasing VDE and molar volume. While we observe this trend in some of the negative ions in Table 1, the dependence of ΔE_{Li}⁺ on VDE and molar volume is more complicated and cannot be a priori predicted. FePO₄ has the smallest VDE and the largest ΔE_{Li}⁺ while reverse is the case with PF₆. The VDEs of ClO₄ and N(SO₂F)₂ are higher than that of FePO₄, but their Li⁺ binding energies are lower. As far as the Li⁺ binding energy is concerned, PF₆ should be the preferred anion in the Li-salt. With the exception of BF₄, all the salts in Table 1 have nearly equal affinity towards water. To see if other superhalogens that have been identified would be better candidates for Li-salts, we have examined six such moieties. Four of these, namely, NO₃, BH₄, B₃H₈, and CB₁₁H₁₂ are halogen-free while two others, namely BeF₃ and AuF₆ do contain halogens. The optimized geometries of these anions are given in FIG. 2.

The geometries of corresponding Li-salts and H₂O interacting with these Li-salts were also determined (not shown). Since AuF₆ is structurally similar to PF₆ and AsF₆which are the anionic parts of commercially used LiPF₆ and LiAsF₆ electrolytes, one could assume that LiAuF₆ may have similar characteristics, but be non-toxic. The calculated VDEs and Li⁺ and H₂O binding energies as well as molar volumes are given in Table 2.

TABLE 2
Calculated Vertical Detachment Energy (VDE, eV), Li⁺ binding
energy (ΔE_{Li}⁺, eV), H₂O Interaction Energy (ΔE_{H2O}, eV), and
molar volume (cm**3/mol) of four potential new electrolytes in Li-ion
battery. Also given for comparison are results for BeF₃ and AuF₆.

| Anions | VDE | ΔE_{Li}⁺ | ΔE_{H2O} | Volume |
|---|---|---|---|---|
| NO₃ | 4.22 | 6.53 | 0.96 | 39.22 |
| BH₄ | 4.50 | 6.62 | 0.92 | 41.62 |
| B₃H₈ | 4.72 | 6.25 | 0.93 | 72.53 |
| CB₁₁H₁₂ | 5.99 | 5.08 | 1.08 | 126.78 |
| BeF₃ | 6.99 | 6.50 | 0.98 | 39.88 |
| AuF₆ | 8.86 | 5.50 | 1.06 | 64.98 |

Among these anions, BH₄ has the highest Li⁺ binding energy in LiBH₄ and the lowest is seen in LiCB₁₁H₁₂. The binding energies of the salts to water are about the same for all the electrolytes in Table 2, but less than those of the current electrolytes given in Table 1. Considering the binding energy of Li⁺ in the electrolyte and its affinity towards water as two of the most relevant parameters, we see that LiCB₁₁H₁₂ has the most desirable characteristics for an electrolyte in Li-ion battery. That it is also halogen-free adds to its value. These properties are associated with the large molar volume of LiCB₁₁H₁₂. Other metal borohydrides such as LiBH₄ and LiB₃H₈ can also be a good choice for electrolytes (see Table 2) as they too are halogen-free.

Another halogen-free electrolyte of choice could be Li₂B₁₂H₁₂. Here, the advantage is that there are two Li ions per each B₁₂H₁₂²⁻ moiety. To study its potential we calculated the energy needed to remove Li⁺ ions from Li₂B₁₂H₁₂ It takes 5.94 eV to remove the first Li⁺, but to remove the second one requires much higher energy, namely, 9.00 eV. Recent experimental works have already demonstrated the potential of Li metal borohydrides for electro-chemical storage ^{[39,40]}.

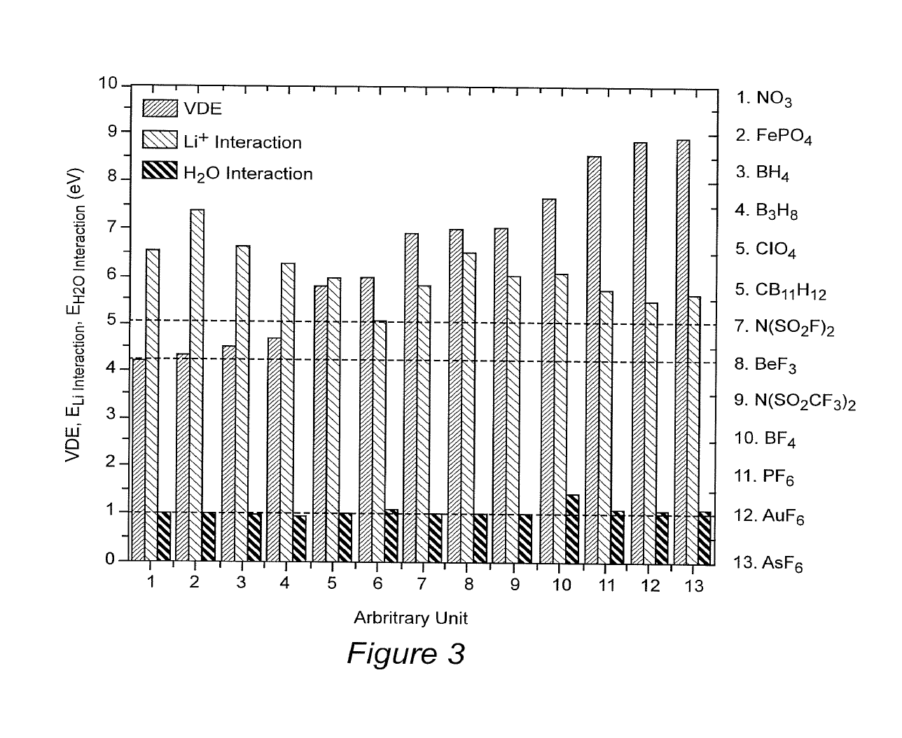

In summary, we have shown that the building blocks of all current halogen-containing electrolytes are superhalogens. We have studied their potential as building blocks of new electrolytes by calculating the binding energies of Li⁺ and H₂O. These results are summarized in FIG. 3. We have identified that among all halogen-free electrolytes LiCB₁₁H₁₂ has exemplary potential. Other metal borohydrides such as LiBH₄, LiB₃H₈, and Li₂B₁₂H₁₂ are also potential candidates.
[1] J. M. Tarascon, M. Armand, Nature 2001, 414, 359-367.
[2] D. Aurbach, Ed. Special Issue on Li Insertion into Host Materials Electrochim. Acta 1999.
[3] G. M. Ehrlich, Handbook of Batteries, third ed., McGraw-Hill, NY and London, 2002.
[4] (a) J.-P. Gabano, Lithium batteries, Academic Press, London, 1983 (b) G.-A. Nazri, G. Pistoia, Lithium batteries: Science and Technology, Springer, 2009.
[5] J. O. Besenhard, Handbook of Battery Materials, Wiley-VCH, 1999.
[6] M. Broussley, G. Pistoia, Industrial Applications of Batteries, Elsevier, Amsterdam; London, 2007.
[7] P. Dan, E. Mengeritsky, Y. Geronov, D. Aurbach, I. Weissman, J. Power Sources, 1995, 54, 143-145.
[8] G. H. Wrodnigg, T. M. Wrodnigg, J. O. Besenhard, M. Winter, Electrochem. Comm. 1999, 1, 148-150.
[9] T. Nakajima, K. Dan, M. Koh, T. Ino, T. Shimizu, J. Fluorine Chem. 2001, 111, 167-174.
[10] M. Schmidt, U. Heider, A. Kuehner, R. Oesten, M. Jungnitz, N. Ignatev, P. Sartori, J. Power Sources 2001, 97-98, 557-560.
[11] J. S. Gnanaraj, M. D. Levi, Y. Gofer, D. Aurbach, J. Electrochem. Soc. 2003, 150, A445 A454.
[12] Y. Ein-Eli, S. R. Thomas, V. Koch, J. Electrochem. Soc. 1996, 143, L195 L197.
[13] D. Aurbach, Y. Gofer, M. Ben-Zion, P. Aped, J. Electroanal. Chem. 1992, 339, 451-471.
[14] X.Sun, H.S. Lee, X. Q. Yang, J. McBreen, J. Electrochem. Soc. 2002, 149, A355-A359.
[15] D. Aurbach, K. Gamolsky, B. Markovsky, Y. Gofer, Electrochim. Acta 2002, 47, 1423-1439.
[16] M. Deepa, S. A. Agnihotry, D. Gupta, R. Chandra, Electrochimica Acta 2004, 49, 373-383.
[17] C. Jung, Solid State Ionics 2008, 179, 1717-1720.
[18] Z. Chen, W. Q. Lu, J. Liu, K. Amine, Electrochim. Acta. 2006, 51, 3322-3326.
[19] Z. Zhang, X. Chen, F. Li, Y. Lai, J. Li, P. Liu, X. Wang, J. Power Sources 2010, 195, 7397-7402.
[20] K. Kanamura, W. Hoshikawa, T. Umegaki, J. Electrochem. Soc. 2002, 149, A339-A345.
[21] S. E. Sloop, J. K. Pugh, S. Wang, J. B. Kerr, K. Kinoshita, Electrochem, Solid State Lett. 2001, 4, A42-A44.
[22] T. Sasaki, Y. Ukyo, P. Novak, Nature Materials 2013, 12, 569-575.
[23] D. Aurbach, B. Markovsky, A. Rodkin, E. Levi, Y. S. Cohen, H-J. Kim, M. Schmidt, Electrochim. Acta 2002, 47, 4291-4306.
[24] M. Broussely, S. Herreyre, P. Biensan, P. Kasztejna, K. Nechev, R. J. Staniewicz, J. Power Sources 2001, 97-98, 13-21.
[25] H. Maleki, S. A. Hallij, J. R. Selman, R. B. Dinwiddie, H. J. Wang, Electrochem. Soc. 1999, 146, 947-954.
[26] D. Aurbach, Y. Talyosef, B. Markovsky, E. Markevich, E., Zinigrad, L. Asraf, J. S. Gnanaraj, H-J. Kim, Electrochim. Acta 2004, 50, 247-254.
[27] J. B. Goodenough, K-S. Park, J. Am. Chem. Soc. 2013, 135, 1167-1176.
[28] G. Gutsev, A. I. Boldyrev, Chem. Phys. 1981, 56, 277-283.
[29] J-D. Chai, M. Head-Gordon, Phys. Chem. Chem. Phys. 2008, 10, 6615-6620.
[30] S. Giri, S. Behera, P. Jena, J. Phys. Chem. A 2014, 118, 638-645.
[31] B. Z. Child, S. Giri, S. Gronert, P. Jena, Chem. Eur. J. 2014, 20, 4736-4745.
[32] S. Giri, B. Z. Child, P. Jena, Chem. Phys. Chem. 2014, DOI: 10.1002/cphc.201402472.
[33] M. J. Frisch, G. W. Trucks, H. B. Schlegel, G. E. Scuseria, M. A. Robb, J. R. Cheeseman, G. Scalmani, V. Barone, B. Mennucci, G. A. Petersson, et al., Gaussian 09, Revision B.01, Gaussian, Inc., Wallingford Conn. 2010.
[34] M. Willis, M. Gotz, A. K. Kandalam, G. Gantefor, P. Jena, Angew. Chem. Int. Ed. 2010, 49, 8966-8970.
[35] S. Behera, D. Samanta, P. Jena, J. Phys. Chem. A 2013, 117, 5428-5434.
[36] C. Paduani, P. Jena, J. Nanopart. Res. 2012, 14, 1035-1043.
[37] D. Samanta, M. M. Wu, P. Jena, Inorg. Chem. 2011, 50, 8918-8925.
[38] M. Gotz, M. Willis, A. Kandalam, G. G. Gantefor, P. Jena, Chem. Phys. Chem. 2010, 11, 853-858.
[39] H-W. Li, Y. Yan, S. Orimo, A. Züttel, C. M. Jensen, Energies 2011, 4, 185-214.
[40] A. Unemoto, M. Matsuo, S. Orimo, Adv. Funct. Mater. 2014, 24, 2267-2279.

While the invention has been described in terms of its several exemplary embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

1. A battery comprising an electrolyte dissolved in a carrier, wherein negative ions of said electrolyte are complex molecules, do not contain halogens, and have electron affinities that are equal to or greater than those of halogens.

2. The battery of claim 1, wherein said battery is a Li ion battery, a Na ion battery or a Mg ion battery.

3. The battery of claim 1, wherein said electrolyte is selected from the group consisting of LiCB₁₁H₁₂, LiBH₄, LiB₃H₈, LiNO₃ and Li₂B₁₂H₁₂.

4. The battery of claim 1, wherein said carrier is selected from the group consisting of ethylene carbonate, dimethyl carbonate, allyl methyl sulfone; diethyl carbonate; diethyl sulfite; ethylene sulfite; ethyl methyl carbonate; fluoroethylene carbonate 99%; 3-(methylsulfonyl)-1-propyne; propylene carbonate; 1,2-propyleneglycol sulfite; propylene sulfate; 1,3-propylene sulfite; vinylene carbonate; trans-2,3-butylene carbonate; {2-[2-(2-methoxyethoxy)ethoxy]ethoxy} trimethylsilane; bis{2-[2-(2-methoxyethoxy)ethoxy]ethoxy}dimethylsilane; {3-[2-(2-(2-methoxyethoxy)ethoxy)ethoxy]-propyl}trimethylsilane; and {[2-(2-(2-methoxyethoxy)ethoxy)ethoxy]-methyl} trimethylsilane.

5. A rechargeable device or vehicle comprising at least one battery according to claim 1.

6. The rechargeable device of claim 5, wherein said rechargeable device is a cell phone, a word processing device, a media storage device, a car, or a tool.

7. A solution comprising
i) an electrolyte selected from the group consisting of LiCB₁₁H₁₂, LiBH₄, LiB₃H₈, LiNO₃ and Li₂B₁₂H₁₂, and
ii) a carrier selected from the group consisting of ethylene carbonate, dimethyl carbonate, allyl methyl sulfone; diethyl carbonate; diethyl sulfite; ethylene sulfite; ethyl methyl carbonate; fluoroethylene carbonate 99%; 3-(methylsulfonyl)-1-propyne; propylene carbonate; 1,2-propyleneglycol sulfite; propylene sulfate; 1,3-propylene sulfite; vinylene carbonate; trans-2,3-butylene carbonate; {2-[2-(2-methoxyethoxy)ethoxy]ethoxy} trimethylsilane; bis{2-[2-(2-methoxyethoxy)ethoxy]ethoxy}dimethylsilane; {3-[2-(2-(2-methoxyethoxy)ethoxy)ethoxy]-propyl}trimethylsilane; and {[2-(2-(2-methoxyethoxy)ethoxy)ethoxy]-methyl} trimethylsilane.

8. The solution of claim 7, for use as an electrolyte in a battery.

9. The solution of claim 8, wherein said battery is a Li ion battery, a Na ion battery or a Mg ion battery.
